(19) United States
(12) Patent Application Publication
(10) Pub. No.: US 2010/0140893 A1
(43) Pub. Date: Jun. 10, 2010

(54) Walker apparatus

(76) Inventor: Ethel Maxine Menefee, Eldorado Springs, MO (US)

Correspondence Address: HOVEY WILLIAMS LLP, 10801 Mastin Blvd., Suite 1000, Overland Park, KS, 66210, US

(21) Appl. No.: 12/315,674

(22) Filed: Dec. 5, 2008

(51) Int. Cl. A61H 3/04; B62M 1/00

(52) U.S. Cl. 280/87.041

(57) ABSTRACT

A seatless, multiple-wheel glide-type walker (10) is provided which has a frame (12) equipped with an offset foot plate (18) oriented for placement of a user's foot thereon in order to support substantially the entire weight of the user. The user's free foot can then be used to propel the walker (10) forwardly along a support surface (16). Rearmost outriggers (80, 82) secured to the frame (12) prevent inadvertent rear overturning of the walker (10). In practice, the user stands with one foot on the foot plate (18) and periodically pushes the walker (10) forwardly using the other foot, all while the user maintains a substantially erect position.

### BACKGROUND OF THE INVENTION

1. Field of the Invention

The present invention is concerned with improved, seatless glide-type walkers designed for use by recovering patients or other semi-invalids. More particularly, it is concerned with such walkers and associated methods wherein the walkers are equipped with a weight-supporting, offset foot plate allowing a user to stand upright with one foot on the foot plate and propel the walker forwardly using the free foot.

2. Description of the Prior Art

A wide variety of patient walkers have been provided in the past. Generally, these walkers include a lightweight, wheeled frame with upper hand grips allowing the user to grasp the frame and gain support while walking. Conventional walkers can be of a tricycle design with a forward swivel wheel and rear trailing wheels, or can be four-wheeled. Use of such walkers can become tedious, particularly as a person becomes more mobile. That is, each step forward requires a corresponding movement of the wheeled frame, with no option for faster or easier movement.

U.S. Pat. No. 5,800,317 describes a four-wheeled side support kneeling walker provided with a relatively high padded support for use by people having a non-functional lower leg, ankle or foot. In this device, the lower leg of the person below the knee rests on the padded support while the person's free foot can be used to propel the device.

UK Patent Application No. 2,127,705 discloses an invalid's walking frame having a central seat as well as a foot rest. In use, an invalid places one foot on the foot plate and takes a step forwardly with his or her free foot. Thereupon, the user sits upon the central seat until another step is taken.

Other prior walkers and similar devices are illustrated in U.S. Pat. Nos. 1,668,623; 2,168,424; 4,078,106; 4,111,445; 4,510,956; 5,039,121; 5,409,028; 5,676,388; 6,161,860; 6,378,883; 6,733,018; 6,739,606; 6,991,243; 7,111,856; US Patent Publications Nos. 2001/0033069; 2007/0283990; 2008/0078431; 2008/0079230; German Patent No. 4,417,922; French Patents Nos. 2,689,082; 2,826,567; and Japanese Publication No. 2002-306552.

As can be appreciated from a study of these prior references, none provides a walker allowing safe, efficient propulsion thereof by a user in an upright, standing position.

### SUMMARY OF THE INVENTION

The present invention overcomes the problems outlined above and provides a greatly improved walker which allows a recovering user to safely and efficiently propel the walker while standing. Generally speaking, the preferred walker of the invention includes a frame, with a plurality of wheels operably coupled with and supporting the frame, including a pair of laterally spaced apart wheels, so as to render the frame mobile. A foot plate is secured to the frame and oriented and operable for a user of the walker to stand with one of the user's feet on the foot plate in a substantially erect position and with the foot plate supporting substantially all of the user's weight. Propulsion of the walker is effected by the user's free foot periodically engaging the floor, allowing the user to “glide” between propulsion steps. In this way, the improved walker can far more efficiently be propelled than is the case with conventional designs.

In one aspect of the invention, the lower peripheries of the walker wheels lie in a common horizontal plane, and the foot plate is positioned in close proximity above this plane. This assures that the walker is stable during operation, as compared to a potentially unstable high placement of the foot plate. Normally, the foot plate is located at most only a few inches above the lower wheel periphery plane. In order to provide further safety, rearwardly extending outriggers are provided which prevent rear overturning of the walker.

In preferred forms, the foot plate is located in an offset relationship to the central fore and aft axis of the walker. This allows sufficient clearance within the confines of the walker for user propulsion as described.

### BRIEF DESCRIPTION OF THE DRAWINGS

FIG. 1 is a front perspective view of a preferred walker in accordance with the invention, shown during use thereof by a person;

FIG. 2 is a rear perspective view of the walker of FIG. 1;

FIG. 3 is an enlarged, fragmentary rear view illustrating a rear wheel of the walker and the orientation of the adjacent foot plate;

FIG. 4 is an enlarged, fragmentary front view illustrating a rear wheel of the walker and the orientation of the adjacent foot plate;

FIG. 5 is a fragmentary side view depicting operation of the rear outriggers of the walker and

FIG. 6 is a schematic plan representation of the wheels of the walker and depicting the offset orientation of the foot plate.

### DETAILED DESCRIPTION OF THE PREFERRED EMBODIMENT

Turning now to the drawings, a walker 10 is illustrated which is designed for use by a person capable of standing in a substantially erect position during use of the walker.

Broadly speaking, the walker 10 includes a rigid frame 12 supported by a plurality of wheels 14 allowing the walker to move across a support surface 16. The walker 10 further includes a rigid, offset foot plate 18 secured to frame 12, as well as a rearmost outrigger assembly 20.

In more detail, the frame 12 includes a pair of upright forward most members 22, 24 interconnected by means of band 26. The members 22, 24 diverge upwardly and outwardly above band 26 and have respective tubular uprights 28, 30 secured to the uppermost ends thereof. The uprights 28, 30 have individual downwardly extending segments 32, 34 forming the lower end of the frame 12. A pair of struts 36, 38 extend between each segment 32, 34 and the corresponding frame members 22, 24. A pair of generally L-shaped hand rails 40, 42 are telescopically received within a corresponding upright 28, 30. The hand rails 40, 42 have endmost hand grips 44, 46 allowing the rails to be grasped by a user. The rails 40, 42 are vertically adjustable within the uprights 28, 30 and can be selectively locked in place by means of friction locks 48, 50. Brake levers 52, 54 are pivotally secured to the rails 40, 42 by means of brackets 56, 58.

The wheels 14 in the disclosed embodiment include a forward, central swivel wheel 60 as well as a pair of rear, laterally spaced apart wheels 62 and 64. The wheel 60 is supported by a yoke 66, the latter being pivotally coupled to the frame members 22, 24 via mount 68. The rear wheels 62, 64 are secured by respective axle pins 70, 72 which are rigidly secured to a corresponding segment 32, 34. The lower peripheries of the wheels 60-64 lie in a common horizontal plane, such as that represented by surface 16.

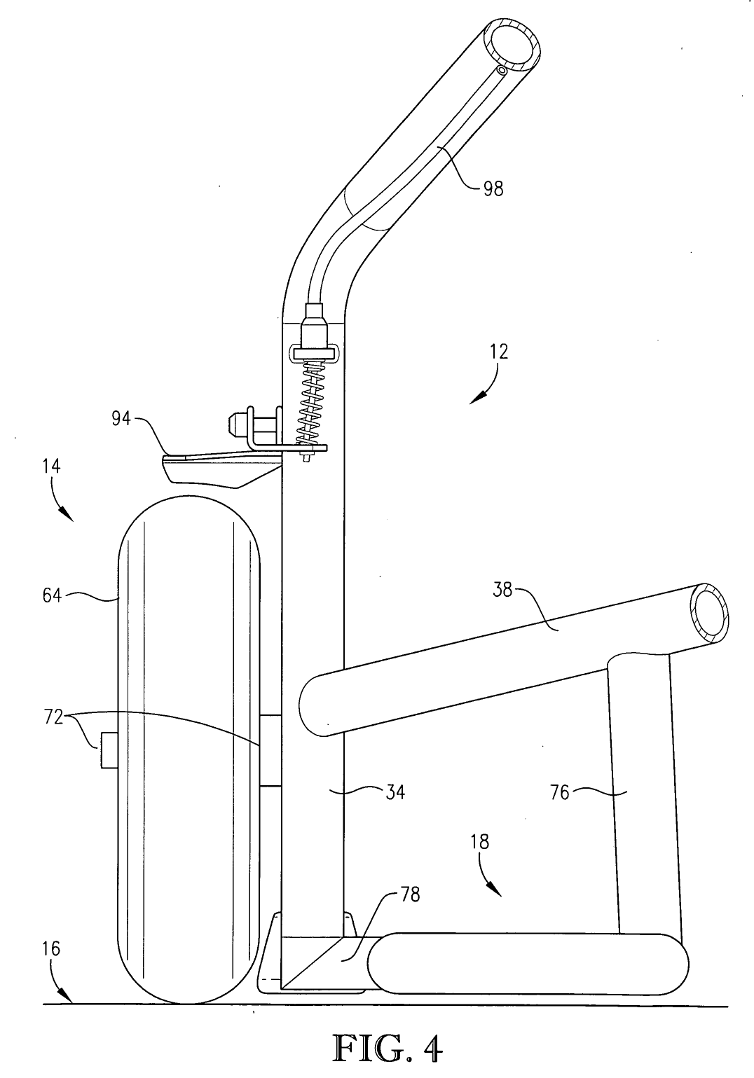

The foot plate 18 is in the form of a substantially flat, rigid body presenting an uppermost foot-supporting area 74. The foot plate 18 is supported by means of an upright frame element 76 secured to strut 38 and the forward inboard margin of the foot plate, and by a lateral connector 78 secured to the outboard margin of the foot plate and the lowermost end of the segment 34 (see FIG. 4).

The outrigger assembly 20 includes a pair of rearwardly extending and depending outriggers 80, 82 respectively secured to the segments 32, 34 by means of spaced upper and lower connection legs 84a, 84b, 86a, 86b. The lowermost ends of the outriggers 80, 82 are equipped with flexible friction pads 88, 90 and are closely adjacent the lower peripheries of the adjacent wheels 62, 64. It will also be observed that pads 88, 90 are located rearwardly of the adjacent wheels 62, 64.

The preferred walker 10 is also equipped with wheel-engaging brake members 92, 94 which are pivotally secured to a corresponding segment 32, 34 as shown. Each brake member 92, 94 is operatively coupled with a corresponding brake lever 52, 54 by means of a conventional actuator cable assembly 96, 98. In this fashion the user may selectively pivot the levers 52, 54 which in turn moves the brake members 92, 94 into braking engagement with the rear wheels 62, 64. Additionally, a flexible carry bag 100 is supported by the frame 12 so as to hold incidentals for the user.

Referring to FIG. 6, it will be seen that the orientation of the wheels 14 of walker 10 provide a tricycle arrangement with a central fore and aft axis 102 extending through forward wheel 60 and centrally between rear wheels 62, 64. It will further be observed that the entirety of foot plate 18 is laterally offset from the axis 102. Very importantly, the foot plate 18 is at a minimal height above the peripheries of the wheels 60-64. Preferably, this height should be up to about 6 inches, more preferably up to about 1½ inches, and most preferably up to about ¾-inch. Such low and offset placement of the foot plate 18 assures that the walker 10 can be safely used by a semi-invalid person.

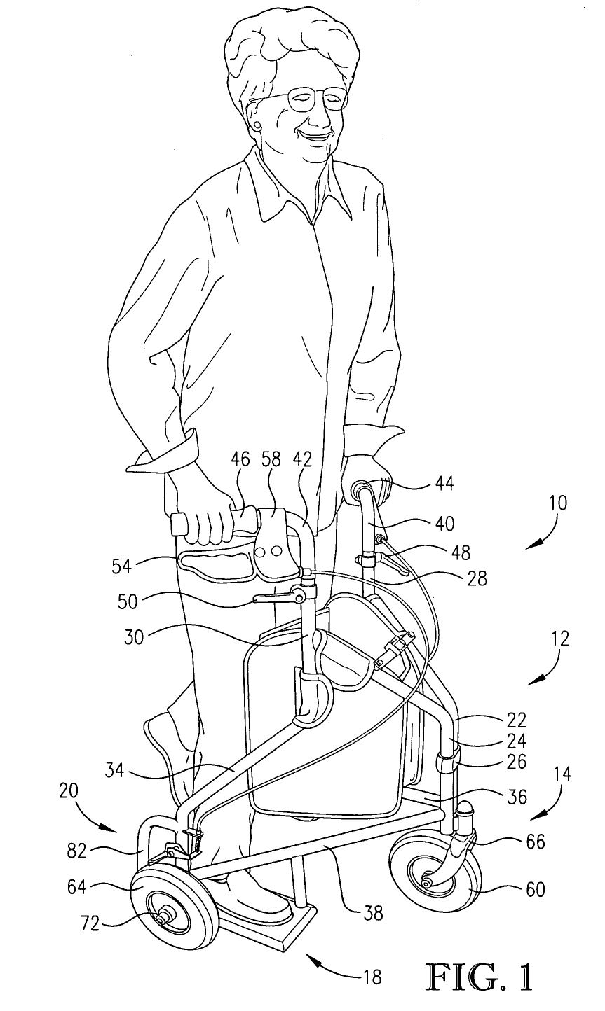

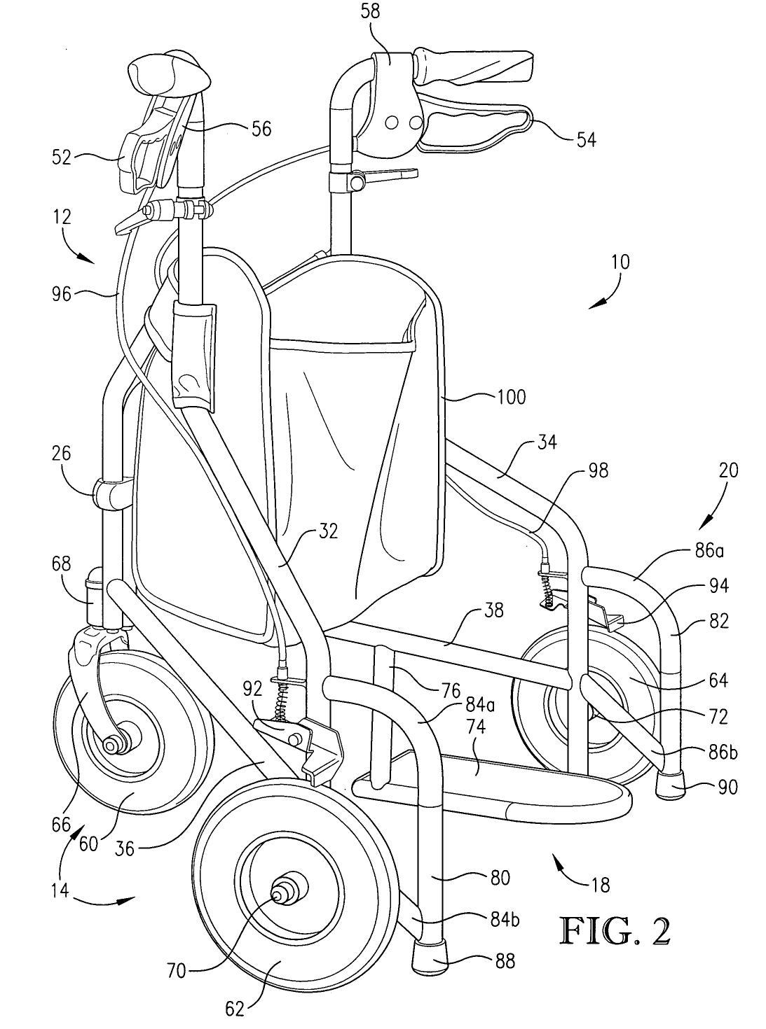

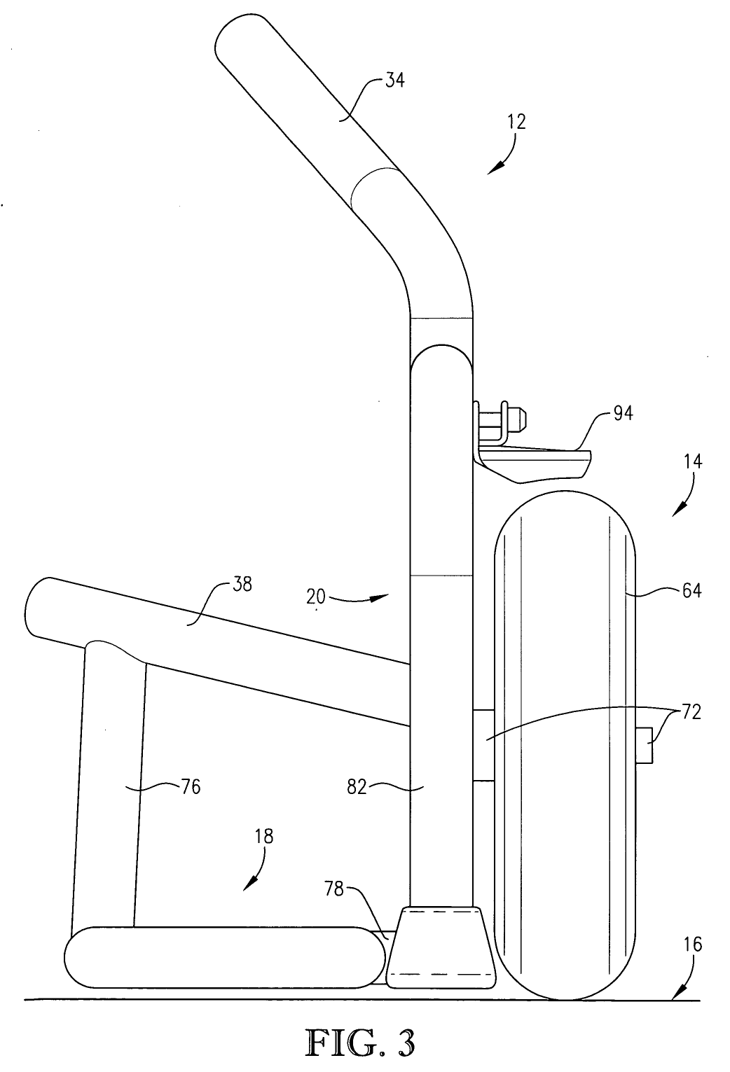

In the use of walker 10 (see FIG. 1) in movement across a support surface 16, a user initially places his or her right foot on the area 74 of foot plate 18 so that substantially all of the user's weight is supported by the foot plate. Thereupon, the user propels the walker 10 forwardly by periodically using his or her left foot to engage the support surface 16, much in the manner of a child's kick-scooter, allowing the walker 10 to glide between foot propulsions. This usage of the walker 10 is carried out while the user maintains his or her substantially erect position on the walker.

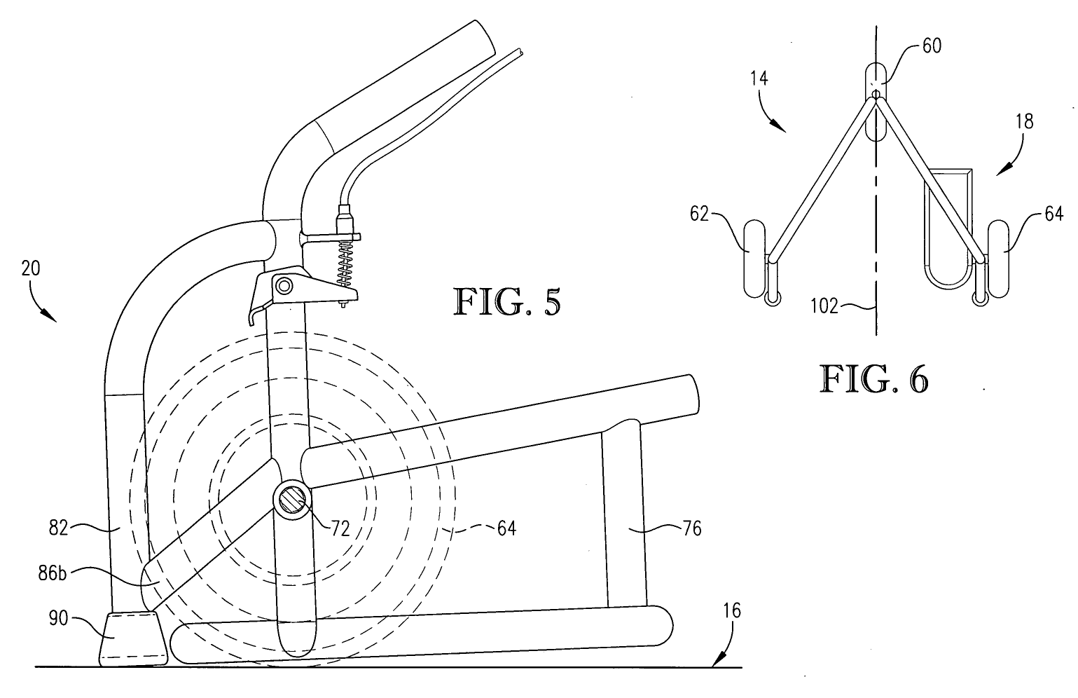

In order to increase the safety of operation of the walker 10, the outrigger assembly 20 is provided. Specifically, in the event that a user places excess weight on the rear portion of the foot plate 18 which could cause rear overturning of the walker, the outriggers 80, 82 quickly come into contact with the support surface 16 in order to prevent such accidental overturning. This operation is illustrated in FIG. 5, where it will be seen that the friction pads 88, 90 engage surface 16.

While the preferred walker of the invention has been described herein, it will be appreciated that a number of variations are possible. By way of example, a four-wheeled walker could be equipped with the foot plate feature of the present invention. Also, for a left footed person, the foot pad 18 could be located adjacent the rear wheel 62. Another possibility would be the use of a bearing or slide component on the underside of foot plate 18 which would engage the support surface 16 along with the wheels 60-64.

I claim:

1. A walker comprising:
a frame;
a plurality of wheels operably coupled with and supporting said frame, including a pair of laterally spaced apart wheels, so as to render the frame mobile; and
a foot plate secured to said frame and oriented and operable for a user of the walker to stand with one of the user's feet on the foot plate in a substantially erect position and with the foot plate supporting substantially all of the user's weight,
said walker having no seat for the user.

2. The walker of claim 1, said plurality of wheels including a forward swivel wheel and a pair of laterally spaced apart rear wheels.

3. The walker of claim 1, the lower peripheries of said plurality ofwheels lying in a common horizontal plane, said foot plate being spaced above said plane a distance of up to about 6 inches.

4. The walker of claim 3, said distance being up to about 1½ inches.

5. The walker of claim 1, including selectively operable braking mechanism attached to said frame, said braking mechanism including at least one brake component engageable with one of said wheels.

6. The walker of claim 1, including a rear outrigger assembly operably coupled with said frame and oriented to prevent rear overturning of the walker.

7. The walker of claim 1, said walker having a central fore and aft axis, said foot plate being located in laterally spaced relationship to said axis.

8. A walker comprising:
a frame;
a plurality of wheels operably coupled with and supporting said frame, including a pair of laterally spaced apart wheels, so as to render the frame mobile; and
a foot plate secured to said frame and oriented and operable for a user of the walker to stand with one of the user's feet on the foot plate in a substantially erect position and with the foot plate supporting substantially all of the user's weight,
the lower peripheries of said plurality of wheels lying in a common horizontal plane, said foot plate being spaced above said plane a distance of up to about 6 inches.

9. The walker of claim 8, said distance being up to about 1½ inches.

10. The walker of claim 8, said plurality of wheels including a forward swivel wheel and a pair of laterally spaced apart rear wheels.

11. The walker of claim 8, including selectively operable braking mechanism attached to said frame, said braking mechanism including at least one brake component engageable with one of said wheels.

12. The walker of claim 8, including a rear outrigger assembly operably coupled with said frame and oriented to prevent rear overturning of the walker.

13. The walker of claim 8, said walker having a central fore and aft axis, said foot plate being located in laterally spaced relationship to said axis.

14. A walker comprising:
a frame;
a plurality of wheels operably coupled with and supporting said frame, including a pair of laterally spaced apart wheels, so as to render the frame mobile; and
a foot plate secured to said frame and oriented and operable for a user of the walker to stand with one of the user's feet on the foot plate in a substantially erect position and with the foot plate supporting substantially all of the user's weight,
said walker having a central fore and aft axis between said laterally spaced apart wheels, said foot plate being located in laterally spaced relationship to said axis.

15. The walker of claim 14, said plurality of wheels including a forward swivel wheel and a pair of laterally spaced apart rear wheels.

16. The walker of claim 14, the lower peripheries of said plurality of wheels lying in a common horizontal plane, said foot plate being spaced above said plane a distance of up to about 6 inches.

17. The walker of claim 16, said distance being up to about 1½ inches.

18. The walker of claim 14, including selectively operable braking mechanism attached to said frame, said braking mechanism including at least one brake component engageable with one of said wheels.

19. The walker of claim 14, including a rear outrigger assembly operably coupled with said frame and oriented to prevent rear overturning of the walker.

20. A method of propelling a walker as set forth in claim 1 across a support surface, said method comprising the steps of:
placing one foot on said foot plate; and
periodically engaging said support surface with the other foot and pushing the walker forwardly by said other foot,
said foot placement and periodic engagement steps being carried out while remaining in a substantially erect position.

21. The method of claim 20, including the step of raising said other foot between the periodic engagements of said other foot and the support surface.

22. A method of propelling a walker as set forth in claim 8 across a support surface, said method comprising the steps of:
placing one foot on said foot plate; and
periodically engaging said support surface with the other foot and pushing the walker forwardly by said other foot,
said foot placement and periodic engagement steps being carried out while remaining in a substantially erect position.

23. The method of claim 22, including the step of raising said other foot between the periodic engagements of said other foot and the support surface.

24. A method of propelling a walker as set forth in claim 14 across a support surface, said method comprising the steps of:
placing one foot on said foot plate; and
periodically engaging said support surface with the other foot and pushing the walker forwardly by said other foot,
said foot placement and periodic engagement steps being carried out while remaining in a substantially erect position.

25. The method of claim 24, including the step of raising said other foot between the periodic engagements of said other foot and the support surface.
